(19) United States
(12) Patent Application Publication
(10) Pub. No.: US 2005/0108248 A1
(43) Pub. Date: May 19, 2005

(54) Limiting use of unauthorized digital content in a content-sharing peer-to-peer network

(76) Inventor: Juha Natunen, Helsinki (FI)

Correspondence Address: YOUNG & THOMPSON, 745 SOUTH 23RD STREET, 2ND FLOOR, ARLINGTON, VA, 22202, US

(21) Appl. No.: 10/956,141

(22) Filed: Oct. 4, 2004

Related U.S. Application Data
(60) Provisional application No. 60/507,524, filed on Oct. 2, 2003.

(51) Int. Cl. G06F 17/30

(52) U.S. Cl. 707/10

(57) ABSTRACT

A technique for limiting the use of unauthorized digital content in a content-sharing network in which digital content is distributed as files (41-48), each of which comprises content information (33) and is associated with characteristic/verification information (31). The method comprises determining a first file (41) whose content information is copyrighted and repeatedly distributing a second file (43-48) in the content-sharing network, wherein the second file is associated with characteristic/verification information (31) that match the characteristic/verification information of said first file, and wherein the second file (43-48) comprises content information (33) that does not match the content information of the first file (41).

### BACKGROUND OF THE INVENTION

The invention relates to a method and apparatus for preventing use of unauthorized digital content in a network. A non-exhaustive list of examples of digital content comprises audio files, video clips, movies, computer programs, or any combination thereof. Unauthorized content means copyrighted content the distribution of which is not authorized by the copyright owner. The invention is particularly usable in peer-to-peer networks in which the roles of client and server are not clear-cut. In other words, the same network nodes can act as both clients and servers.

Napster was an early example of a server-based technology that was used to distribute digital content on the Internet. It was widely used to distribute unauthorized content, which is why it was closed in its original form. Napster relied on a dedicated server, which is why it was rather easy to shut down. Since then, unauthorized content is mainly distributed in peer-to-peer networks, such as Kazaa, which are difficult to shut down because the network is built on an ad-hoc basis from computers that act as ordinary Internet clients. While the Kazaa network, used herein as an example, may employ so-called supernodes, the network cannot be shut down merely by tracking down one supernode and closing it. It should be understood that an exact definition of a peer-to-peer network is not essential to the invention because the serverless operation of such networks is part of the problem and not part of the solution. The operation of Kazaa is described in reference 1, see section “How Kazaa works”.

### BRIEF DESCRIPTION OF THE INVENTION

An object of the present invention is to provide a method and an apparatus for implementing the method so as to alleviate the above problem. The object of the invention is achieved by a method and an arrangement which are defined in the attached independent claims. The preferred embodiments of the invention are disclosed in the dependent claims.

In order to keep the description compact, the following description uses the term ‘copyright owner’, but in practice this term also comprises any party authorized by the copyright owner.

An aspect of the invention is a method for limiting unauthorized digital content in a content-sharing network in which digital content is distributed as files. For the purposes of the invention, a file is an addressable data entity that has a finite size. As is well known, multiple usable files can be compressed into a single distribution file. Each file comprises characteristic information in addition to content information. Content information is the actual content of the file, that is, the part of the file that is used to produce a working computer program, audio/video information, or the like. The characteristic information is information that is used for retrieving and/or describing the file. The characteristic information comprises a file name or other network address. Depending on the protocols used in the content-sharing network, the characteristic information may also comprise file size, artist/producer identification, or the like. In case of a file used for distributing computer software, the content of the executables and data files constitute the content information. In case of audiovisual files (music, images or video clips), the content information comprises audible sound and/or viewable image/video information.

The invention is based on the idea that technically good but unauthorized content is buried in a multitude of technically bad content that has matching characteristic information. Thus the good but unauthorized content is buried under a proverbial haystack of technically bad content.

This technique suffers from the drawback that content-sharing networks can bypass this proverbial haystack by maintaining user-updated lists of bad content. For example, the Kazaa network that is used herein as an example, provides each file with verification information which is sometimes called a hash code. A user who has discovered bad content masquerading as good content, can declare the bad content as fake, after which the bad content disappears from the list of shareable files.

The invention is particularly useful in networks like Kazaa, in which the verification information (hash) is predominantly calculated over thethe characteristic information and the beginning of the file. Accordingly, introducing bad content may not radically change the verification information (hash) calculated by Kazaa, as long as the bad content is not near the beginning of the file. It has been found that changing the content of a file near its end may only alter the last few bytes of the hash calculated by Kazaa, whereby a falsified file that produces a perfectly-matching hash can be generated by a brute-force algorithm.

Another problem is how to distribute the bad content so that users trying to retrieve good but unauthorized content will actually receive bad but authorized content. This problem is solved by distributing the bad content from a node that emulates a node in the content-sharing peer-to-peer network. In other words, from the point of view of other nodes in the network, the node used by the copyright owner to distribute bad content looks like a normal node, such as a node participating in the Kazaa network. The node used by the copyright owner is, however, programmed to intercept a file request and substitute bad content for the requested good content, or the node used by the copyright owner may supply a bad hash code for bad content, whereby a client that requested good content will actually download bad content. One option for the copyright owner is to actually download a good file (a “first file”), then change the content to bad and re-publish the bad file (a “second file”).

Yet another problem is how to know what characteristic information is or will be used to distribute the content in the content-sharing network, because the copyright owners do not distribute the content in the network themselves. There are two approaches to this problem. In one approach, the copyright owners monitor the content-sharing network for suspicious characteristic information. Because the characteristic information must give a reasonable indication of copyrighted content, such as the name of a popular piece of music, the copyright owners can monitor or install search agents to monitor the content-sharing network for characteristic information that closely match the names of popular pieces of music. In response to detecting such a file, called a “first file”, the copyright owner can repeatedly distribute a second file that comprises characteristic information, including verification information, such that the characteristic information and verification information of the first file and second file match, but the second file comprises “bad” content information, that is, its content information does not match the content information of the first file.

In another approach, the copyright owner tries to anticipate the characteristic information that will be used to distribute the content in the content-sharing network. The anticipation is based on creating technically good files for distribution by any of the available file-creation programs, in which process the copyright owner will learn the characteristic information created by the file-creation programs. In the context of music or video information, such file-creation programs are colloquially called “rippers”. The copyright owner then falsifies the content and distributes it in the content-sharing network, so as to make finding technically good but unauthorized content more difficult.

It should be understood that it is very difficult to completely eliminate unauthorized content, but the invention is expected to make unauthorized content so inconvenient to use that many users will choose authorized content instead.

### BRIEF DESCRIPTION OF THE DRAWINGS

In the following the invention will be described in greater detail by means of preferred embodiments with reference to the attached [accompanying] drawings, in which

FIG. 1 shows the relevant parts of a content-sharing network 10;

FIG. 2 shows an exemplary layout of a content falsification logic;

FIG. 3 shows the relevant parts of a file used for content sharing; and

FIG. 4 shows how a file is mutated between repeated attempts to download it.

### DETAILED DESCRIPTION OF THE INVENTION

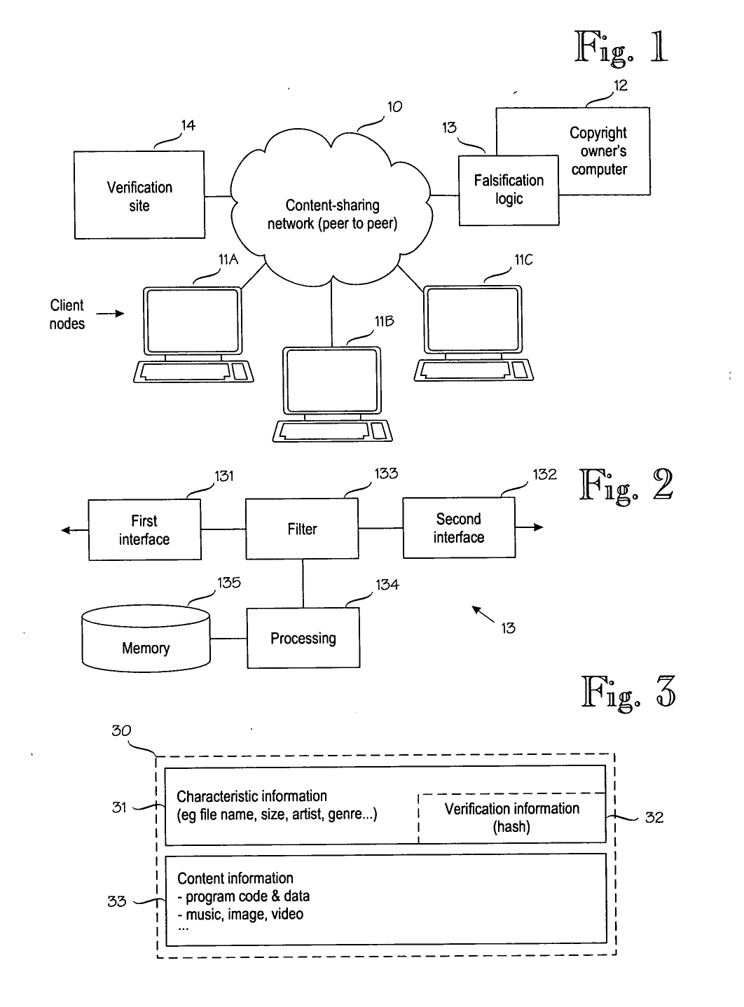

FIG. 1 shows the relevant parts of a content-sharing network 10. The content-sharing network 10 typically operates on top of the Internet. Kazaa is a good but non-exclusive example of a content-sharing network. It is also a peer-to-peer network, which means that its operation is largely independent of dedicated servers or other special nodes. Instead, such functions are implemented as distributed functions in the peer-to-peer network. By way of example, FIG. 1 shows three conventional client nodes 11A, 11B and 11C, which publish certain portions of their internal memories for the benefit of others, but such unauthorized publication is detrimental to the copyright owners. Reference numeral 12 denotes a copyright owner's node. From the point of view the client nodes 11A to 11C, the copyright owner's node 12 looks like another conventional client node. Copyright owners have tried to hamper the use of unauthorized content by publishing files that contain bad content but masquerade as good. The users of the content-sharing network can report such bad files to a verification site 14.

In order to bypass the verification service provided by the verification site 14, the copyright owner's node 12 comprises or is closely coupled to a falsification logic 13, the operation of which will be further described in connection with FIG. 2.

FIG. 2 shows an exemplary layout of a content falsification logic, denoted by reference numeral 13 in FIG. 1. Assuming that the falsification logic 13 is to be used in a peer-to-peer content-sharing network, the falsification logic 13 comprises a first interface 131 to support communications with the peer-to-peer network. It also comprises a second interface 132 to support communications with a content-sharing client owned or authorized by the copyright owner. There is a filter 133 between the two interfaces 131 and 132. In a typical implementation, the filter 133 passes traffic from the first interface 131 to the second interface 132. In addition, the filter 133 copies traffic from the first interface 131 to a processing section 134. The processing section 134 is also connected to a memory 135 which stores segments of content which is copyrighted by the copyright owner. The processing section 134 monitors the traffic from the first interface 131 in order to detect content downloading request for such copyrighted content. The detection is based on comparing the characteristic information of the request with the characteristic information stored in the memory 135. In response to detecting a content downloading request for copyrighted content, the processing section responds to the content downloading request by supplying content that has the requested characteristic information but falsified content.

There are many ways to carry out the content falsification. For instance, the processing section 134 may slightly but randomly change the content supplied to the content-sharing network interface 131. The processing section 134 may also employ several directories and files so that each file has a unique network address, but the processing section 134 may falsify the network addresses by renaming files and/or directories or substituting files with falsified ones.

It is beneficial if the falsified files have verification information (such as the UUHash used in the Kazaa) that matches the verification information used by generally available file distribution programs in the network. This is particularly easy to implement in the Kazaa network because the UUHash used in the Kazaa is predominantly calculated from the beginning of the file. This means that the beginning of the file should not be falsified. Leaving the beginning of the file intact provides another benefit in that the network users will not know immediately whether the content of the file has been falsified or not.

The first and second interfaces 131, 132 can be conventional interfaces that exist in each node that is connected to the corresponding networks. The filter 133 can be implemented in hardware or software.

The processing section 134 can implemented as a dedicated data processor (computer) or as a process in a node (computer) that is attached to the peer-to-peer network. The memory 135 is preferably a computer of RAM and/or hard disk memory, as is conventional in computer technology.

FIG. 3 illustrates the concept of a file for the purposes of the invention. Reference numeral 30 generally denotes a logical file. A logical file means a collection of data that a user wishes to download, along with certain information needed to locate the data and verify its contents. A logical file may or may not correspond to a physical file. The two major sections of the logical file 30 are its characteristic information 31 and content information 33. The characteristic information 31 typically comprises verification information 32, such as a hash-type code that is calculated over the sections 31 (without section 32) and 33, or parts of those sections. The verification information 32 is demarcated with a dashed outline to illustrate the fact that the verification information 32, such as a hash code, is a property that can be derived from the file but it is not necessarily stored with the file.

In the Kazaa network, which is used herein as an example, the content information 33 is contained in one physical file, whereas the characteristic information 31 and verification information 32 of all shareable files are contained in a second physical file.

An exemplary step-by-step technique for distributing falsified content in the Kazaa network is as follows:
1. Prepare, in a computer, two directories, C:\good\ . . . and C:\bad\ . . . The first directory contains good content and the second directory contains falsified content.
2. Log in to Kazaa with the computer.
3. Publish the first directory as shareable.
4. When Kazaa has calculated the characteristic information and verification information, rename the first directory something else and the second directory C:\good\ . . . Now all the network addresses (the computer's IP address and the directory/file names) that Kazaa believes to point to good content actually point to falsified content.

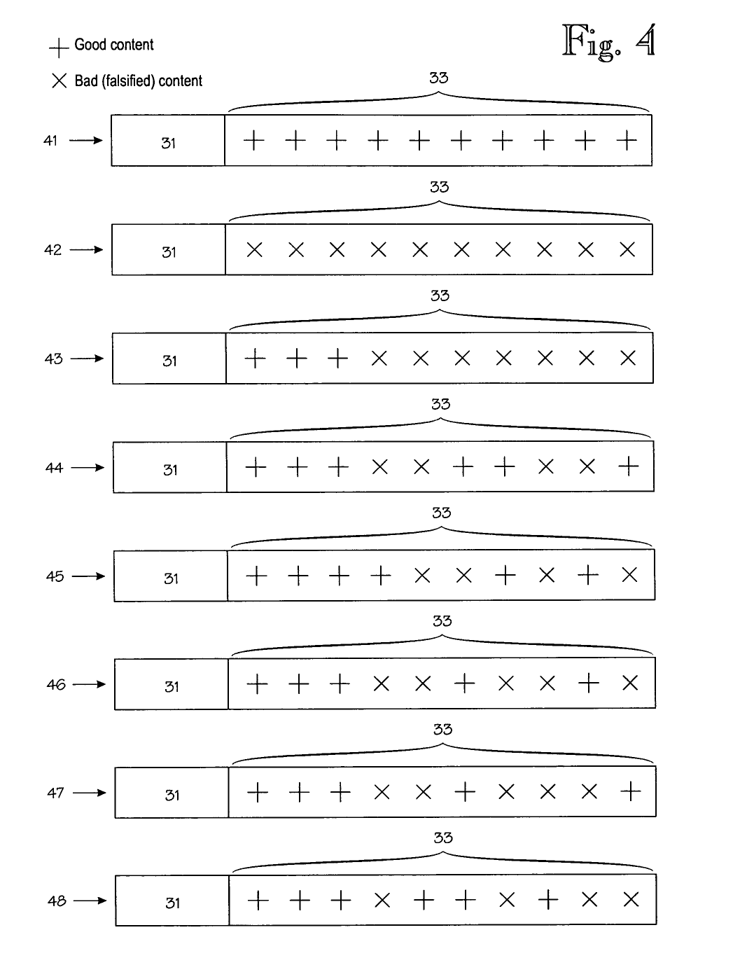

FIG. 4 shows how a file is mutated between repeated attempts to download it. FIG. 4 shows eight versions 41 to 48 of a file 30 as shown in FIG. 3. In the first version 41, the content information 33 is entirely good, as shown by the ten plus signs. In the second version 42, the content information 33 is entirely bad (falsified), as shown by the ten “X” signs. A file with an entirely falsified content information is not a perfect way to combat unauthorized file sharing, because such a file is easy to detect by users. Versions 43 to 48 show preferred falsifications in which the beginning of the content information 33 is intact. Assuming that a version 43 is published in the content-sharing network, its content is mutated in the network for the following reason. Many users have network strongly asymmetric connections in which the upload bandwidth is a mere fraction of the download bandwidth. Thus it takes, say, ten typical nodes to satisfy the download request of one downloading user. If several users are publishing file versions with matching characteristic information 31 but with different content, a downloading user may receive one segment from a first participating user, the next segment from a second user, and so on. The result is that as long as the characteristic information of files with falsified content is kept sufficiently credible (ie, close to either existing files or files that are created from good content with available file-distribution programs), different versions 43-48 of files will mutate in the file-sharing network. Such mutation will hamper the attempts to declare files with falsified content to the verification service 14.

It will be apparent to a person skilled in the art that, as the technology advances, the inventive concept can be implemented in various ways. The invention and its embodiments are not limited to the examples described above but may vary within the scope of the claims.

### REFERENCES

1. www.kent.ac.uk/aw/undergraduate/modules/ip/handouts/2002_{—}3/Kazaa_essay.doc

1. A method for limiting the use of unauthorized digital content in a content-sharing network in which digital content is distributed as files, wherein each file comprises content information and is associated with characteristic information and verification information, the method comprising:
(a) determining a first file whose content information is copyrighted;
(b) repeatedly distributing a second file in the content-sharing network, wherein the second file is associated with characteristic information and verification information that match the characteristic information and verification information, respectively, of said first file, and wherein the second file comprises content information that does not match the content information of the first file.

2. A method according to claim 1, wherein step (a) comprises detecting the first file in the content-sharing network.

3. A method according to claim 1, wherein step (a) comprises processing a copyrighted file with a distribution program.

4. A method according to claim 3, wherein steps (a) and (b) are performed before publishing said digital content.

5. A method according to claim 1, wherein step (b) comprises falsifying a network address of the one or more second files.

6. A method according to claim 1, wherein step (b) is performed in response to detecting a file request that indicates the characteristic information and verification information of the first file.

7. An apparatus for limiting the use of unauthorized digital content in a content-sharing network in which digital content is distributed as files, wherein each file comprises content information and is associated with characteristic information and verification information, the apparatus comprising:
a first interface for connecting to content-sharing network;
a second interface for connecting to a content-sharing client authorized by a copyright owner;
a filter; and
a processing section;
wherein the filter is configured to copy to the processing section such traffic that originates from the first interface and is destined to the second interface;
wherein the processing means is configured to detect in the copied traffic a file request that indicates a first file having content information that is copyrighted by the copyright owner, and in response to such detection, respond to the file request by supplying a second file that is associated with characteristic information and verification information that match the characteristic information and verification information, respectively, of said first file, and wherein the second file comprises content information that does not match the content information of the first file.

8. An apparatus according to claim 7, wherein the apparatus is configured to first publish the characteristic information, verification information and content information of a copyrighted file in the content-sharing network and then change the content information of the copyrighted file.

9. A set of computer-readable program media, the set comprising computer program code, wherein execution of said computer program code in a computer attached to a content-sharing network causes said computer to carry out the steps of claim 1.
